(19) United States
(12) Patent Application Publication
(10) Pub. No.: US 2009/0006431 A1
(43) Pub. Date: Jan. 1, 2009

(54) SYSTEM AND METHOD FOR TRACKING DATABASE DISCLOSURES

(75) Inventors: Rakesh Agrawal, San Jose, CA (US); Alexandre V. Evfimievski, San Jose, CA (US); Gerald Kiernan, San Jose, CA (US); Raja Velu, Palo Alto, CA (US)

Correspondence Address: LAW OFFICE OF DONALD L. WENSKAY, P.O. Box 7206, Ranco Santa Fe, CA, 92067, US

(73) Assignee: International Business Machines Corporation, Armonk, NY (US)

(21) Appl. No.: 11/772,054

(22) Filed: Jun. 29, 2007

(51) Int. Cl. G06F 17/30

(52) U.S. Cl. 707/100; 707/E17.014

(57) ABSTRACT

A system and method is provided for identifying the source of an unauthorized database disclosure. The system and method stores a plurality of past database queries and determines the relevance of the results of the past database queries (query results) to a sensitive table containing the unauthorized disclosed data. The system and method also ranks the past database queries based on the determined relevance. A list of the most relevant past database queries can then be generated which are ranked according to the relevance, such that the highest ranked queries on the list are most similar to said disclosed data. Three techniques used in embodiments of the invention include partial tuple matching, statistical linkage and deviation probability gain.

### FIELD OF INVENTION

The present invention generally relates to systems and methods for tracking the sources of unauthorized database disclosures, and particularly to systems and methods for auditing database disclosures by ranking potential disclosure sources.

### BACKGROUND

As enterprises collect and maintain increasing amounts of personal data, individuals are exposed to greater risks of privacy breaches and identity theft. Many recent reports of personal data theft and misappropriation highlight these risks. As a result, many countries have enacted data protection laws requiring enterprises to account for the disclosure of personal data they manage. Hence, modern information systems must be able to track who has disclosed sensitive data and the circumstances of disclosure. For instance, the U.S. President's Information Technology Advisory Committee in its report on healthcare recommends that healthcare information systems must have the capability to audit who has accessed patient records.

The problem of auditing a log of past queries and updates by means of an audit query that represents the leaked data has been addressed by various techniques in the prior art. One method is to identify the subset of queries that have disclosed the information specified by the auditor. Unfortunately, the number of such queries that need to be tracked by the audit can become prohibitive. In one such technique, described in R. Agrawal, R. Bayardo, C. Faloutsos, J. Kiernan, R. Rantzau, and R. Srikant. Auditing compliance using a hippocratic database. In 30th Int'l Conf. on Very Large Data Bases, Toronto, Canada, August 2004. The suspicious queries are identified by finding past queries in the log whose results depend on the same “indispensable” data tuples as the audit query; a tuple is considered indispensable for a query if its omission makes the result of the query different. However, given some sensitive data, it is often difficult to formulate a concise audit query with near-perfect recall and precision. Moreover, the tuples in the sensitive table may have undergone a certain amount of arbitrary perturbation. Finally, the number of suspicious queries produced can be very large, necessitating an ordering based on relevance for an auditor's investigation.

Database watermarking has also been proposed to track the disclosure of information. Database fingerprinting can additionally identify the source of a leak by injecting different marks in different released copies of the data. Both the techniques require data to be modified to introduce a pattern and then recover the pattern in the sensitive data to establish disclosure. These techniques depend on the availability of a set of attributes that can withstand alteration without significantly degrading their value. They also require that a large portion of the pattern is carried over in the sensitive data.

Oracle Corporation offers a “fine-grained auditing” function where the administrator can specify that queries should be logged if they access specified tables. This function logs various user context data along with the query issued, the time it was issued, and other system parameters such as the “system change number”. Oracle also supports “flashback queries” whereby the state of the database can be reverted to the state implied by a given system change number. A logged query can then be rerun as if the database was in that state to determine what data was revealed when the query was originally run. However, there does not appear to be any automated facility to find the queries that are the subject of an audit.

Accordingly, there is a need for systems and methods for tracking unauthorized database disclosures. There is also a need for such systems and methods which can narrow the search down to a manageable number of possible queries. Furthermore, there is a need for such systems and methods which do not require data to be modified to identify the source of leakage (e.g. using fingerprinting).

### SUMMARY OF THE INVENTION

To overcome the limitations in the prior art briefly described above, the present invention provides a method, computer program product, and system for tracking database disclosures.

In one embodiment of the present invention a method for identifying the source of an unauthorized database disclosure comprises: storing a plurality of past database queries; determining the relevance of the results of the past database queries (query results) to a sensitive table containing disclosed data; ranking the past database queries based on the determined relevance; and generating a list of the most relevant past database queries ranked according to the relevance, whereby the highest ranked queries on the list are most similar to the disclosed data.

In another embodiment of the present invention, a method for identifying the source of an unauthorized database disclosure comprises: storing a plurality of past database queries; determining the relevance of the results of the past database queries (query results) to a sensitive table containing disclosed data by measuring the proximity of the query results to the sensitive table based on common pieces of information between the query result and the sensitive table; ranking the past database queries based on the determined relevance; and generating a list of the most relevant past database queries ranked according to the relevance, whereby the highest ranked queries on the list are most similar to the disclosed data.

In a further embodiment of the present invention a method for identifying the source of an unauthorized database disclosure comprises: storing a plurality of past database queries; determining the relevance of the results of the past database queries (query results) to a sensitive table containing disclosed data by finding the best one-to-one match between the closest tuples in the query results and the sensitive table by generating a score for each the one-to-one match, and evaluating the overall proximity between the query results and the sensitive table by aggregating the scores of individual matches; ranking the past database queries based on the determined relevance; and generating a list of the most relevant past database queries ranked according to the relevance, whereby the highest ranked queries on the list are most similar to the disclosed data.

In an additional embodiment of the present invention, an article of manufacture for use in a computer system tangibly embodying computer instructions executable by the computer system to perform process steps for identifying the source of an unauthorized database disclosure, the process steps comprising: storing a plurality of past database queries; determining the relevance of the results of the past database queries (query results) to a sensitive table containing disclosed data; ranking the past database queries based on the determined relevance by evaluating the proximity of the sensitive table to the query results by computing the gain in probability for tuples in the sensitive table through their maximum-likelihood derivation from the query results; and generating a list of the most relevant past database queries ranked according to the relevance, whereby the highest ranked queries on the list are most similar to the disclosed data.

Various advantages and features of novelty, which characterize the present invention, are pointed out with particularity in the claims annexed hereto and form a part hereof. However, for a better understanding of the invention and its advantages, reference should be make to the accompanying descriptive matter together with the corresponding drawings which form a further part hereof, in which there is described and illustrated specific examples in accordance with the present invention.

### BRIEF DESCRIPTION OF THE DRAWINGS

The present invention is described in conjunction with the appended drawings, where like reference numbers denote the same element throughout the set of drawings:

FIG. 1 is a schematic structure of a database disclosure tracking system and method in accordance with one embodiment of the invention;

FIG. 2a is a table of sensitive table S and query tables Q₁, Q₂ and Q₃ in accordance with one embodiment of the present invention;

FIG. 2b is a table of full and partial tuple frequency counts across queries Q₁, Q₂, Q₃ in FIG. 2a;

FIG. 2c is a table of the computation of frequency histograms for queries Q₁, Q₂, Q₃ in FIG. 2a;

FIG. 3 is a list of process steps for the partial tuple matching (PTM) method in accordance with an embodiment of the invention;

FIG. 4a is a diagram illustrating the assigning of weights in the statistical tuple linkage (STL) method in accordance with an embodiment of the invention;

FIG. 4b is a diagram illustrating the finding of a 1-to1 matching to maximize the sum of the weights shown in FIG. 4a in accordance with an embodiment of the invention;

FIG. 5 is a list of process steps for the partial tuple matching (PTM) method in accordance with an embodiment of the invention;

FIG. 6 is a list of process steps for the derivation probability gain (DPG) method in accordance with an embodiment of the invention;

FIGS. 7a-d illustrate four steps in the derivation probability gain (DPG) method in accordance with an embodiment of the invention;

FIG. 8 shows a table of a comparison of the PTM, STL and DPG methods of the present invention;

FIG. 9 is an illustration showing the impact of highly non-uniform attributes on ranking; and

FIG. 10 is a table illustrating the impact of size of S on the performance of the PTM, STL and DPG methods of the present invention.

### DETAILED DESCRIPTION OF THE INVENTION

The present invention overcomes the problems associated with the prior art by teaching a system, computer program product, and method for tracking database disclosures. In the following detailed description, numerous specific details are set forth in order to provide a thorough understanding of the present invention. Those skilled in the art will recognize, however, that the teachings contained herein may be applied to other embodiments and that the present invention may be practiced apart from these specific details. Accordingly, the present invention should not be limited to the embodiments shown, but is to be accorded the widest scope consistent with the principles and features described and claimed herein. The following description is presented to enable one of ordinary skill in the art to make and use the present invention and is provided in the context of a patent application and its requirements.

The various elements and embodiments of invention can take the form of an entirely hardware embodiment, an entirely software embodiment or an embodiment containing both hardware and software elements. Elements of the invention that are implemented in software may include but are not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Although the present invention is described in a particular hardware embodiment, those of ordinary skill in the art will recognize and appreciate that this is meant to be illustrative and not restrictive of the present invention. Those of ordinary skill in the art will further appreciate that a wide range of computers and computing system configurations can be used to support the methods of the present invention, including, for example, configurations encompassing multiple systems, the internet, and distributed networks. Accordingly, the teachings contained herein should be viewed as highly “scalable”, meaning that they are adaptable to implementation on one, or several thousand, computer systems.

### 1. Introduction

The following scenario illustrates a practical application of the proposed auditing system. Sophie, who is the privacy officer of Physicians Inc., comes across a promotion that includes a table of names of patients who have been treated and benefited from a newly introduced HIV treatment. Sophie becomes suspicious that this table might have been extracted from queries run against her company's database. There are very many queries run everyday, but fortunately they are logged along with the timestamp and other information such as who ran them. The database system also versions previous state before updating any data item to meet the need of reconstructing history as needed. Sophie can use the techniques proposed in this paper to identify and rank the queries that she should examine first for investigating this potential data leak.

The present invention includes an auditing methodology that ranks potential disclosure sources according to their proximity to the leaked records. Given a sensitive table that contains the disclosed data, our methodology prioritizes by relevance the past queries to the database that could have potentially been used to produce the sensitive table. The present invention provides three conceptually different measures of proximity between the sensitive table and a query result. One measure is inspired by information retrieval in text processing, another is based on statistical record linkage, and the third computes the derivation probability of the sensitive table in a tree-based generative model.

In accordance with the present invention, we assume there is a data table called sensitive table, which is suspected to have originated from one or more queries that were run against a given database. Information on the past queries is available from a query log. Since the number of queries can be very large, our goal is to rank them so that the more likely sources of leakage can be examined by the auditor first.

The queries are ranked based on the proximity of their results with the sensitive table. The present invention provides three methods of measuring proximity:

1. Partial Tuple Matching (PTM) This method measures the proximity of a query result to the sensitive table by considering common pieces of information (partial tuple matches) between the tuples of the two tables, while factoring in the rarity of a match at the same time. This method is inspired by the TF-IDF (term frequency-inverse document frequency) measure from the prior art field of information retrieval.

2. Statistical Tuple Linkage (STL) This method employs statistical record matching techniques and mixture model parameter estimation via expectation maximization to find the best one-to-one match between the closest tuples in the two tables, and then evaluates the overall proximity by aggregating the scores of individual matches. This proximity measure has roots in the prior art of record linkage.

3. Derivation Probability Gain (DPG) This method, inspired by the minimum description length principle, evaluates proximity of the sensitive table to the query result table by computing the gain in probability for the sensitive tuples through their maximum-likelihood derivation from the query result table.

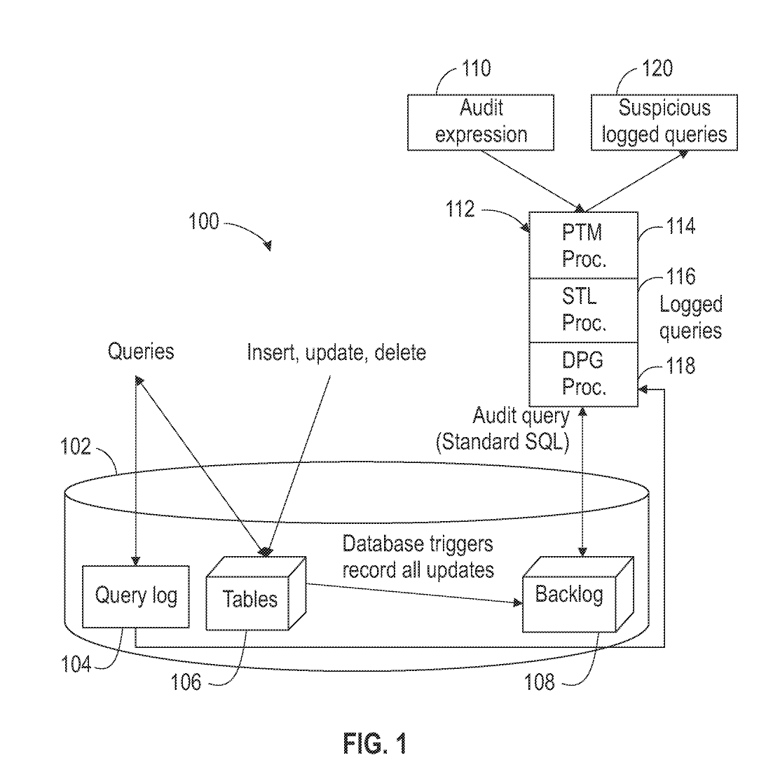

FIG. 1 illustrates an audit system 100 in accordance with one embodiment of the invention. During normal operation, the text of every query processed by a database system 102 is logged along with annotations such as the time when the query was executed, the user submitting the query, and the query's purpose into query log 104. The database system 102 uses database triggers to capture and record all updates to base tables 106 into backlog tables (not shown) of a backlog database 108 for recovering the state of the database at any past point in time. Queries, which are usually predominant, do not write any tuple to the backlog database.

To perform an audit, an auditor formulates an audit expression 110 that declaratively specifies the data whose disclosure is to be audited (i.e. sensitive data). Sensitive data could be for example, information that a doctor wants to track for a specific individual that could help to resolve disclosure issues during an audit process. Audit expressions are designed to essentially correspond to structured query language (SQL) queries, allowing audits to be performed at the level of an individual cell of a table. The audit expression 110 is processed by an audit query audit processor 112, which uses one or more of the three methods of the present invention to identify queries in the query log that are likely candidates as the source of the sensitive data being audited. In particular the query audit processor 112 may include one or more of the following three components; partial tuple matching (PTM) processor 114, statistical tuple linkage (STL) processor 116, and derivation probability gain (DPG) processor 118 implementing the three methods respectively as described in detail below. The query audit processor 112 generates an output including the suspicious logged queries 120.

Backlog tables of backlog database 106 as shown in FIG. 1 are used to reconstruct the snapshot of the database at the time a logged query was run. Backlog tables are maintained by database triggers which respond to updates over base tables. However, the same backlog organization can instead be computed using DB2 V8 replication services. DB2 V8 uses the database recovery log to maintain table replicas. A special DB2 V8 replication option can create a replica whose organization is similar to backlog tables described above. Thus, using DB2 V8, backlog tables can be maintained asynchronously from the recovery log instead of being maintained using triggers. Oracle offers flash-back queries as yet another alternative to the backlog organization of FIG. 1. A SQL query can be run against any previous snapshot of the database using Oracle SQL language extensions.

### 2. Auditing Query Logs

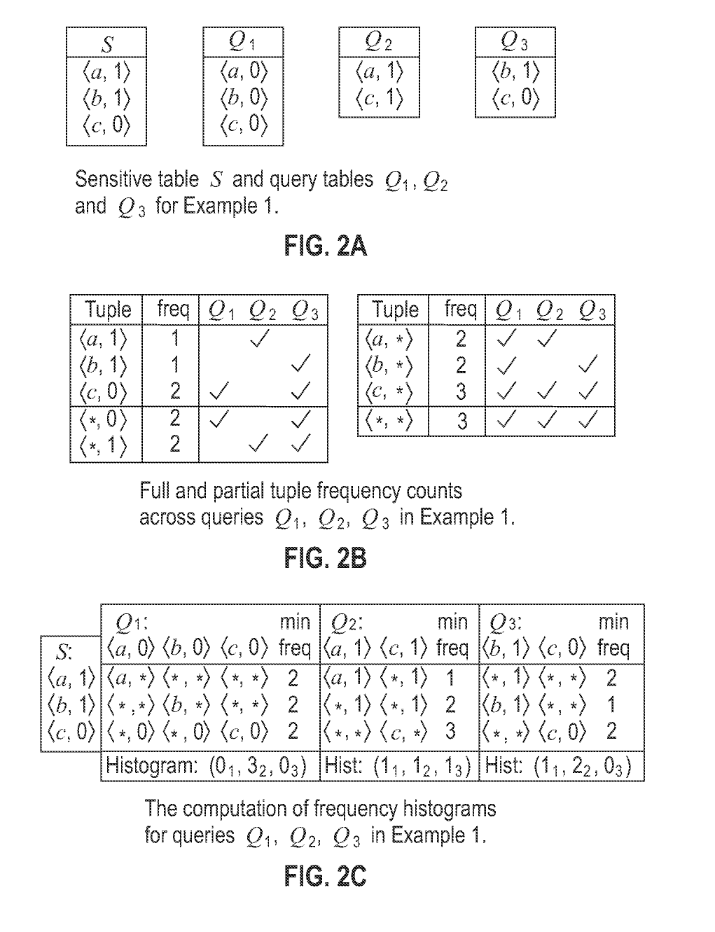

Referring now to FIG. 2a there is shown a table S that contains sensitive data suspected to have been misappropriated (the sensitive table for short). S has schema A1×A2× . . . ×Ad where d is the number of attributes and Aj is the domain of the j^{th} attribute. The auditor wants to find a ranked list of the past queries to the database D that could have potentially been used to produce S. I should be noted that the queries may be perfectly legitimate, but their results may have subsequently been stolen or inappropriately disclosed. The exact cause of the disclosure is determined by comprehensive investigation, which is beyond the scope of the present invention. The present invention provides systems and methods that focuses and prioritizes the leads.

All the past queries issued over a period of time against the database D are available in a query log L. We assume, for simplicity, that the results produced by all logged queries Q1, . . . , Qn have the same schema as S, namely A1×A2× . . . ×Ad where d is the number of attributes and Aj is the domain of the j^{th} attribute. For conciseness, we will refer to the table resulting from the execution of a query Q simply as the query table and abuse the notation by denoting it also as Q. We will view a table as a matrix and use lower index sᵢ or qᵢ for tuples in the i^{th} position of their corresponding tables. We will use upper index sᵢ^{j} qᵢ^{j} to refer to the j^{th} attribute of the i^{th} tuple.

As mentioned earlier, it will be assumed that all the logged queries Qᵢ have the same schema as the sensitive table S. In general, the schema of the logged queries, as well as of the database itself, may differ from the schema of the sensitive table. While the problem of schema matching remains complex for the purpose of the present invention it will be assuming that the auditor provides a one-to-one mapping query V to map attributes Aj ε S to attributes of the database tables Aj ε Ti ε D.

The candidate set of suspicious queries Q1, . . . , Qn comprises of queries that have at least one table and at least one projected attribute in common with those mapped by V. If needed, we use V to rename the projected attributes of Qᵢ to match the schema of S. If a query table has extra attributes beyond the common schema, we omit them. If an attribute Aj ε S is not projected by Qi, we add a column of null values in its place to match S's schema.

In accordance with one embodiment of the invention, the organization of the query log and the recovery of the state of the database at the time of each individual query, may be accomplished using the techniques taught in R. Agrawal, et al. Auditing Compliance Using a Hippocratic database. In 30^{th} Int'l Conf. on Very Large Data Bases, Toronto, Canada, August 2004, the contents of which are hereby incorporated by reference. Briefly, for each table T in the database, all versions of tuples t ε T are maintained in a backlog table such that the version of T at the time of any query Qᵢ in the query log can easily be reconstructed from its backlog table. For the purposes of the present invention, we ignore schema changes that might have occurred over time.

### 3. Partial Tuple Matching

In accordance with one embodiment of the present invention, a method of measuring proximity between query results and tables is inspired by prior work in information retrieval. In order to rank text documents by relevance to keyword searches, a document is commonly represented by a weighted vector of terms *. A non-zero value in yₖ indicates that the term tₖ is present in the document, and its weight represents the term's search value. The weight depends on the term frequency in the document and on the inverse frequency across all documents that use the term (TF-IDF). Term frequency refers to the number of times a term appears in a document. Inverse document frequency is the number of documents with the term. The smaller the number of documents having tₖ, the more valuable tₖ is for relevance ranking.

In the context of database auditing, the terms are tuples in the query tables and the documents are the query tables Q₁ through Qₙ, while the tuples in the sensitive table S is the collection of keywords to search for. However, there are significant differences between this context and that of information retrieval:
1. Term frequency in Qᵢ, i.e. the number of duplicate tuples, adds no value to a match between S and Qᵢ.
2. Document frequency, i.e. the number of tables in {Q₁, . . . , Qₙ} having a given tuple t ε S, is critically important: we are looking precisely for the queries that could have contributed t to S.
3. Tuples can match partially, when only a subset of their attributes match. Even a single common value, if rare, can be a significant indication of disclosure.
4. The number of logged queries n={Q₁, . . . , Qₙ} may be very large or very small, depending on how these queries were selected.

We could address the issue of partial matches by treating attribute values as terms, rather than tuples as terms. However, if only combinations of attribute values are rare, but not the individual values, such single-attribute matching would miss important disclosure clues. To handle combinations, we enrich the “term vocabulary” by all possible partial tuples, with some attribute values replaced with wildcards (here denoted by “*”). For example, one full tuple [symbol] a,b,c [symbol] is augmented with six partial ones: [symbol] *,b,c [symbol] , [symbol] a,*,c [symbol] , [symbol] a,b,* [symbol] , [symbol] a,*,* [symbol] , [symbol] *,b,* [symbol] and [symbol] *,*,c [symbol] . Note that the 7^{th} partial tuple of [symbol] a,b,c [symbol] , namely [symbol] *,*,* [symbol] , is valid, but has no matching value.

Definition 1. Table Qᵢ is said to contain, or instantiate, a partial tuple t when the wildcards in t can be instantiated with attribute values to produce a tuple q ε Qᵢ. The frequency count of a partial tuple t in a collection of tables {Q₁, . . . , Qₙ}, denoted by freq(t), is the number of the Qᵢ's that contain t.

If we take a table with 1000 tuples and 30 attributes and augment it with all possible partial tuples, we will have about 1000·2³⁰≈10¹² tuples, too many even by modern database standards. In accordance with one embodiment of the invention, we limit this combinatorial explosion by restricting attention to the terms we search for, i.e. the partial tuples contained in S. Furthermore, for each query table Qᵢ we generate a single partial tuple per each tuple in S. Every Qᵢ is thus represented by the same number |S| of partial tuples, regardless of its own size |Qᵢ|. For each query Qᵢ and for each tuple s ε S we find a single “representative” partial tuple t such that (1) t can be instantiated to s and to some tuple q ε Qᵢ, and (2) t has the smallest frequency count freq(t) across all such tuples. Condition 1 ensures that t represents common information between s and Qᵢ, while condition 2 picks a tuple most valuable for our search. Such tuple t can always be found among intersections s [symbol] q for q ε Qᵢ defined below:

Definition 2. Let s and q be two tuples of the same schema. Their intersection t=s [symbol] q has a value at each attribute where s and q share this same value, and has wild-cards at all other attributes. In other words, t is the most informative partial tuple that can be instantiated to both s and q. Example: [symbol] a,b,c [symbol] [symbol] [symbol] a,b,d [symbol] = [symbol] a, b, * [symbol] .

Tuple t that satisfies conditions 1 and 2 may not be unique; however, its frequency count is unique as a function of Qᵢ and s and is computed as follows:

$$min f ( s , {Q}_{i} ) {=}^{def} {min}_{q ∈ {Q}_{i}} freq ( s q ) .$$

Every Qᵢ corresponds to a multiset (bag) of exactly |S| minimum frequency counts minf(s,Qᵢ), one count for each tuple s ε S. It is convenient to represent this multiset as a histogram: a sequence of numbers h₁,h₂, . . . , hₙ where hₖ is the number of tuples s ε S giving the minimum frequency count of k. Denote this frequency histogram by hist(Qᵢ):

hist(Qᵢ)=(h₁,h₂, . . . , hₙ)

where hₖ=|{s ε S|minf (s, Qᵢ)=k}|. (1)

Given the critical importance of document frequency counts in relevance ranking, we decided to use the above frequency histogram hist(Qᵢ) to describe the relationship between Qᵢ and S. We could assign a weight to each common partial tuple based on its frequency count, then aggregate the weights to compute a proximity score; but this is risky due to the high variability in the number of the Qᵢ's. So, we sidestep weight aggregation and simply assume that a common tuple t with lower freq(t) is infinitely more important than any number of tuples with higher freq(t). That is, frequency-1 matches between S and Qᵢ are infinitely more valuable than frequency-2 matches, and these are infinitely more valuable than frequency-3 matches etc. Hence, we rank the queries {Q₁, . . . , Qₙ} in the decreasing lexicographical order of their frequency histograms:

(h₁, h₂, . . . , hₙ)>(h′₁, h′₂, . . . h′ₙ) [symbol] ∃K=1 . . . n:h₁=h₁ & . . . & h_{K-1}=h′_{K-1} & h_{K}>h′_{K}. (2)

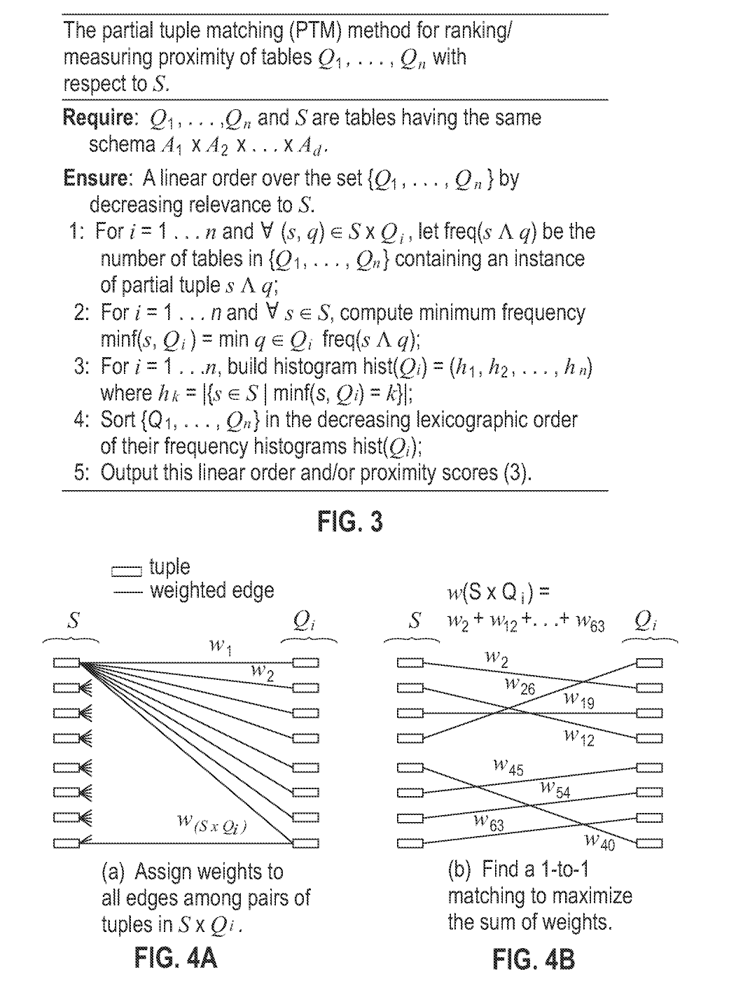

Now partial tuple matching (PTM) method is fully defined. FIG. 3 shows a summary of the steps for the PTM method for ranking/measuring proximity of tables Q₁, . . . , Qₙ with respect to S in accordance with one embodiment of the present invention. Below is an example to illustrate the PTM method:

### EXAMPLE 1

Consider a schema of two attributes A₁×A₂, where A₁ has domain {a,b,c, . . . } and A₂ has domain {0,1}. Let the sensitive table S and three query tables Q₁, Q₂ and Q₃ be as defined in Table 1 shown in FIG. 2a. The frequency counts freq(t) for all involved partial tuples are given in Table 2 shown in FIG. 2b. The computation of s [symbol] q for all tuple pairs between S and Qᵢ, the computation of minimum frequency counts, and the subsequent formation of histograms is given in Table 3 shown in FIG. 2c. The ranking output is as follows: (0₁,3₂,0₃)<(1₁,1₂,1₃)<(1₁,2₂,0₃) [symbol] Q₁<Q₂<Q₃.

To obtain a numerical proximity measure from a frequency histogram in an order-preserving manner, pick some α>0, e.g. α=1, and define

$$prox ( {Q}_{i} , S ) {=}^{def} f ( hist ( {Q}_{i} ) ) , where \\ f ( {h}_{1} , {h}_{2} , … , {h}_{n} ) = {\sum }_{k = 1}^{n} \frac{{h}_{k}}{α + {h}_{k}} {\prod }_{l - 1}^{k - 1} \frac{α}{( α + {h}_{1} ) ( α + {h}_{1} + 1 )} \qquad ( 3 )$$

Let us justify this measure by the following lemma:

Lemma 1. In all valid settings, hist(Qᵢ)>hist(Qⱼ) if and only if prox(Qᵢ,S)>prox(Qⱼ,S).

Proof. Denote fₖ=f(hₖ,hₖ+1, . . . , hₙ,0, . . . ,0); notice the following recursion:

$${f}_{n + 1} = 0 ; \\ \begin{matrix}{f}_{k} = \frac{{h}_{k}}{α + {h}_{k}} + \frac{α \cdot {f}_{k + 1}}{( α + {h}_{k} ) ( α + {h}_{k} + 1 )} \\ = \frac{{h}_{k}}{α + {h}_{k}} + ( \frac{{h}_{k} + 1}{α + {h}_{k} + 1} - \frac{{h}_{k}}{α + {h}_{k}} ) {f}_{k + 1}\end{matrix} \qquad ( 4 )$$

Assume hist(Qᵢ)=(h₁, h₂, . . . , hₙ₎>(h′₁, h′₂, . . . , h′ₙ)=hist(Qⱼ) as defined in (2); then hₖ=h′ₖ for k=1 . . . K−1 and h_{K}>h′ₖ implying h_{K}≧h′ₖ+1 since these are two integers. Denote f′ₖ=f(h′ₖ, h′ₖ₊₁, . . . ,0, . . . ,0). From (4) we have 0≦f_{K+1}^{(′)}<1 by induction, and furthermore,

$$\frac{{h}_{k}^{′}}{α + {h}_{k}^{′}} \leq {f}_{k}^{′} < \frac{{h}_{k}^{′} + 1}{α + {h}_{k}^{′} + 1} \leq \frac{{h}_{k}}{α + {h}_{k}} \leq {f}_{k} < \frac{{h}_{k} + 1}{α + {h}_{k} + 1}$$

Therefore fₖ>f′ₖ, and f₁>f′₁ too because hₖ=h′ₖ for k=1 . . . K−1 and recursion (4) is strictly monotone with respect to fₖ₊₁.

The above proves that hist(Qᵢ)>hist(Qⱼ) implies prox(Qᵢ, S)>prox(Qⱼ, S). Analogously, hist(Qᵢ)<hist(Qⱼ) implies prox(Qᵢ, S)<prox(Qⱼ, S), and “=” implies “=”. Because for every pair of histograms one of these alternatives holds, the lemma is proven.

### 4. Statistical Tuple Linkage

Record linkage is a well-established area of statistical science, which traces its origin to the dawn of the computer era. Ever since government organizations and private businesses began collecting large volumes of records about individual people, they faced a pressing need to efficiently identify and match different records about the same person. Attribute values in such records are often missing, misspelled, have multiple variants, are approximate or even intentionally modified, exacerbating the complexity of the linkage problem. For datasets where direct key-based matching does not work, probabilistic record linkage methods were developed. Here we adapt one popular method based on finite mixture models and measure proximity between tables by optimally matching their records.

### 4.1 Statistical Tuple Linkage Framework

We have S, which is an |S|× d table with schema A₁×A₂× . . . ×A_{d}, and Q, which is a |Q|×d table with the same schema. Assume that each tuple in S and in Q describes one entity (e.g. person) from a certain unspecified collection. We want to find pairs of tuples [symbol] sᵢ,qᵢ [symbol] from S×Q that both describe the same entity.

Definition 3. For every pair of tuples sᵢ ε S and q_{i′}εQ, define a d-dimensional comparison vector γ=γ(sᵢ,q_{i′}) such that γ^{j}=1 if the tuples match on the j^{th} attribute and 0 otherwise. If the j^{th} attribute is missing in one of the tuples, let γⁱ=*:

γ(sᵢ,qᵢ)= [symbol] γ¹, γ², . . . , γ^{d} [symbol] :

$${∀}_{j} = 1 … d \text{:} {γ}^{j} = \{ \begin{matrix}1 , & {s}_{i}^{j} = {q}_{{i}^{′}}^{j} \\ 0 , & {s}_{i}^{j} \neq {q}_{{i}^{′}}^{j} \\ * , & missing {s}_{i}^{j} or {q}_{{i}^{′}}^{j}\end{matrix}$$

Overall we have |S|·|Q| vectors γ(sᵢ,q_{i′}), one for each pair of tuples.

Let Γ= [symbol] γ₁ [symbol] ᵢ₌₁^{|S| |Q|} denote the |S| |Q| matrix of all comparison vectors. We shall define a probabilistic model that describes the distribution of these vectors. The model is centered around the notion of true matching between two tuples. We assume that there is an unknown function

Match: S×Q→{M, U}, (5)

where “M” means “tuples match” and “U” means “tuples do not match.” We can also think of M and U as a partition of S×Q into two disjoint subsets formed by matching and non-matching tuple pairs. For example, if S and Q contain tuples representing distinct individuals, a pair sᵢ ε S, q_{i′}ε Q is a true match if sᵢ and q_{i′} represent the same person. In this case at most min(|S|,|Q|) can be true matches (belong to M), the remainder of S×Q belong to U.

The record linkage process attempts to classify each tuple pair [symbol] sᵢ,qᵢ [symbol] as either M or U, by observing comparison vectors γ(sᵢ,q_{i′}). This clarification is possible because the distribution of γ(sᵢ,q_{i′}) for M-labeled tuple pairs is very different from its distribution for U-labeled pairs. Let us define two sets of conditional probabilities:

m(γ)=P[γ(sᵢ,q_{i′})| [symbol] sᵢ,qᵢ [symbol] ε M];

u(γ)=P[γ(sᵢ,q_{i′})| [symbol] sᵢ, q_{i′} [symbol] εU (6)

In other words, m(γ) is the probability to find a comparison vector γ if indeed the tuples are in a true match, whereas u(γ) is the probability of observing γ when the tuples are not a true match. If [symbol] sᵢ, q_{i′} [symbol] ε M, then the probability of γⱼ=1 for most attributes with non-missing values should be high, unless the data contains many errors. If instead [symbol] sᵢ,q_{i′} [symbol] ε U, then the probability of an accidental attribute match depends upon the distribution of attribute values in S and Q.

A comparison vector γ that involves missing values, i.e. with γ^{j}=* for some attributes, stands for the set

I(γ)={γ ε {0,1}^{d}|∀ⱼ=1 . . . d: γ^{j}≠* [symbol] γ′^{j}=γ^{j}

Accordingly, for such γ we define

m(γ)=Σ_{γ′ ε I(γ)}u(γ′). (7)

Fellegi and Sunter formalized the matching problem in I. P. Fellegi and A. B. Sunter. A theory for record linkage. Journal of the American Statistical Association, 64:1183-1210, December 1969, which is hereby incorporated by reference. Let us briefly describe the main elements of their work and state the fundamental theorem. Let the comparison space [symbol] be the set of all possible realizations of γ. In our case, assume that no values are missing and set [symbol] ={0,1}^{d}. A (probabilistic) matching rule D is a mapping from [symbol] to a set of three random decision probabilities

D(γ)= [symbol] P(\hat{M}|γ), P (Û|γ)

[symbol]

such that P(\hat{M}|γ)+P(\hat{?}|γ)+P(Û|γ)=1

Here, \hat{M} is the decision that there is a true match between tuples sᵢ and qᵢ, and Û is the decision that there is no true match. In practice, there will be cases where we will not be able to make such clear cut decisions, hence we allow for a “possible match” decision denoted by “\hat{?}”. We define two types of errors:
1. Linking unmatched comparisons:

μ=P(\hat{M}|U)=Σ_{γε} [symbol] u(γ)P(\hat{M}|γ); (8)
2. Non-linking a matched comparison:

λ=P(Û)|M)=Σ_{γε} [symbol] m(γ)P(Û|γ). (9)

We write a matching rule D as D(μ,λ, [symbol] ) to explicitly note its errors μ(D)and λ(D).

Definition 4. A matching rule D(μ,λ, [symbol] ) is said to be optimal among all rules satisfying (8) and (9) if

P(\hat{?}|D)≦P(\hat{?}|D′)

for every D′(μ,λ, [symbol] ) in this class. Intuitively, less ambiguous matching rules should be preferred to others with the same level of errors.

In order to construct the optimal rule, select two thresholds T_{μ}>T_{λ} and fix the pair (μ,λ) of admissible error levels such that

$$μ = {\sum }_{\frac{m ( γ )}{u ( γ )} \geq {T}_{μ}} u ( γ ) , λ = {\sum }_{\frac{m ( γ )}{u ( γ )} \leq T λ} m ( γ ) \qquad ( 10 )$$

Define a deterministic matching rule D₀(μ,λ, [symbol] ) for any comparison vector γ as follows:

$${D}_{0} ( {λ}_{k} ) = \{ \begin{matrix}\hat{M} & if {T}_{μ} \leq m ( γ ) / u ( γ ) , \\ \hat{?} & if {T}_{λ} < m ( γ ) / u ( γ ) < {T}_{μ} \\ \hat{U} & if m ( γ ) / u ( γ ) \leq {T}_{γ}\end{matrix} \qquad ( 11 )$$

Note that for a (μ,λ) not constrained by (10) the optimal rule may have to make probabilistic decisions for borderline γ.
Theorem 1 (Fellegi, Sunter). The matching rule D₀(μ, γ, [symbol] ) defined by(11) is the optimal matching rule on [symbol] at the error levels of μ and λ.

### 4.2 Mixture Model and EM

As Theorem 1 demonstrates, the evaluation of m(γ)/u(γ) is crucial in deciding whether or not two records truly match. But how can we compute the conditional probabilities m(γ) and u(γ)? Their definitions in equation (6) cannot be directly applied because no pair of records is labeled with M or U. There is no way to compute them that works in all cases; however, given certain assumptions about the data, m(γ) and u(γ) can be efficiently estimated. Quite commonly in the prior art the assumptions combine blocking and mixture models.

Blocking consists in labeling a large fraction of S×Q pairs with U (non-match) according to some heuristic. This method substantially reduces the scope of the matching problem by eliminating pairs of tuples that are obvious non-matches. For example, a blocking strategy for census data may exclude tuple pairs that do not match on zip code, with the assumption being that two people in different zip codes cannot be the same person.

We shall assume that, after blocking, all pairs and their comparison vectors γₖ Γ with index k=1 . . . K_{B} are left unlabeled, whereas all γₖ with index k=K_{B}+1 . . . |S| |Q| are labeled with U.

For the mixture model, let us assume that the comparison vectors γₖ=γ(sᵢ,q_{i′}) are conditionally independent from each other given the M- or U-label of the pair (sᵢ,q_{i′}). In addition, assume that the M- and U-labels are themselves independently assigned to each pair, with probability p ε [0,1] to assign an M-label and probability 1-p to assign a U-label. Then, the probability that some unlabeled pair [symbol] s,q [symbol] has a comparison vector \hat{γ} equals

$$\begin{matrix}P [ γ ( s , q ) = \hat{γ} ] = ρpP [ \hat{γ} \vert M ] + ( 1 - p ) P [ \hat{γ} \vert U ] \\ = pm ( \hat{γ} ) + ( 1 - p ) u ( \hat{γ} )\end{matrix}$$

For a pair [symbol] s,q [symbol] whose label is known to be U (through blocking) the probability of both the label and vector γ equals just (1-p) u(\hat{γ}). Thus, the probability for the entire observed matrix of comparison vectors [symbol] and the observed U-labels assigned by blocking is given by the product

$${\prod }_{k = 1}^{{K}_{B}} ( pm ( {γ}_{k} ) + ( 1 - p ) u ( {γ}_{k} ) ) \cdot {\prod }_{k = {K}_{B} + 1}^{\vert S \vert \vert Q \vert} ( 1 - p ) u ( {γ}_{k} ) \qquad ( 12 )$$

Now one can use maximum likelihood estimation to search for m(γ)and u(γ) that maximize the probability given by equation 12. This estimation is carried out through the EM algorithm described in H. O. Hartley Maximum likelihood estimation from incomplete data. Biometrics, 14:174-194, 1958 and in A. P. Dempster, N. M. Laird, and D. B. Rubin. Maximum likelihood from incomplete data via the EM algorithm. Journal of the Royal Statistical Society, 39(1):1-38, 1977, both of which are herein incorporated by reference. An alternative approach is when the mixture model and EM covers only the tuple pairs left unlabeled by blocking [15]. This would increase p, but could introduce bias.

Before we turn to EM, let us denote by zₖ ε {0,1} a random variable such that

zₖ=1 [symbol] Match [symbol] Sᵢ₍ₖ₎, q_{i′(k)} [symbol] =M

In our generative model, we assume that each zₖ follows Bernoulli (p). Note that the zₖ's are not known for k=1 . . . K_{B}, i.e. pairs left unlabeled after blocking, and zₖ=0 for the blocked pairs. Recall that index k refers to a tuple pair [symbol] Sᵢ₍ₖ₎, q_{i′(k)} [symbol] in product S×Q, while index j on top of γₖ^{j} denotes a coordinate of γₖ for attribute Aⱼ.

Given a joint distribution P [X,Z|Θ] with an observed random vector X, a hidden random vector Z and a parameter vector Θ, the EM algorithm is an iterative procedure to find parameters Θ* where the marginal distribution P[X|ΘT]=Σ_{Z} P[X,Z|Θ] achieves a local maximum. This algorithm is often used to estimate parameters of mixture models. The iteration step of the algorithm is given by the following formula:

$${⊖}_{n + 1} = {arg max}_{Θ} {E}_{Z ∼ P [ Z \vert X , {Θ}_{n} ]} log P [ X , Z \vert ⊖ ] \qquad ( 13 )$$

In our case, X includes the observed comparison matrix Γ and the blocking U-labels [symbol] Zₖ [symbol] _{k=Kb+1}^{|S||Q|} while the hidden labels are Z= [symbol] Zₖ [symbol] ₖ₌₁^{K}^{_{B}}, and we want to estimate probabilities [symbol] p,m(γ),u(γ) [symbol] _{γ ε 1′}. The joint distribution of both X and Z equals the product

$$P \text{[} X , Z \vert ⊖ ] = {\prod }_{k = 1}^{\vert S \vert \vert Q \vert} {( pm ( {γ}_{k} ) )}^{zk} ( ( I - p ) u ( {γ}_{k} ) ) {\text{)}}^{1 - zk}$$

The logarithm of this expression is linear with respect to the zₖ's, making it easy to take the expectation:

$${E}_{Z ∼ P [ Z \vert X , Θ ]} log P [ X , Z \vert Θ ] = {\sum }_{k = 1}^{\vert S ‖ Q \vert} {\overline{Z}}_{k} log ( pm ( {γ}_{k} ) ) \qquad ( 14 )$$

Computation of the expectations Z̅ₖ̅ for non-blocked pairs is the “E-step” of the EM algorithm, and the subsequent recomputation of next-iteration parameters \hat{p}, \hat{m}(γₖ), û(λₖ) to maximize equation (14) is the “M-step.” Denote the n^{th} iteration parameters by pₙ,mₙ(γₖ), uₙ(γₖ); then the E-step is given by the Bayes formula as follows:

$$\begin{matrix}{\overline{z}}_{k} = P [ {z}_{k} = 1 \vert {γ}_{k} ] = P [ M \vert {γ}_{k} ] \\ = \frac{{p}_{n} {m}_{n} ( {γ}_{k} )}{{p}_{n} {m}_{n} ( {γ}_{k} ) + ( 1 - {p}_{n} ) {u}_{n} ( {γ}_{k} )} , k = 1 … {K}_{B}\end{matrix} \qquad ( 15 )$$

For the M-step, we could maximize equation (14) over the entire range [symbol] m(γ),u(γ) [symbol] _{γ ε Γ}, but so many parameters would over fit the data. So, we assume that individual attribute matchings are conditionally independent given the “true matching” label M or U. For γε{0,1}^{d} we get

m(γ)=Πⱼ₌₁^{d}(m^{j})^{γ}^{^{j}}(1−m^{j})^{1-γ}^{^{j}} m^{j}=P[γ^{j}=1|M]

u(γ)=Πⱼ₌₁^{d}(u^{j})^{γ}^{^{j}}(1−u^{j})^{1-γ}^{^{j}} u^{j}=P[γ^{j}=1|U]

If a comparison vector γε{0,1,*}^{d} has missing values, it is treated as a set I(γ) of possible complete vectors γ′ε{0,1}^{d} as in (7), or equivalently as a predicate P_{γ}(λ′) [symbol] γ′ε Iγy). The probability of P_{γ}(λ′) to be satisfied given label M or U is

$$\begin{matrix}m ( γ ) = {\prod }_{j : {γ}^{j} \neq *} {( {m}^{j} )}^{{γ}^{j}} {( 1 - {m}^{j} )}^{1 - {γ}^{j}} , \\ u ( γ ) = {\prod }_{j : {γ}^{j} \neq *} {( {u}^{j} )}^{{γ}^{j}} {( 1 - {u}^{j} )}^{1 - {γ}^{j}}\end{matrix}$$

With the above assumption, maximizing equation (14) computes the n+1^{st} iteration parameters \hat{p} and [symbol] \hat{m}^{j}, û^{j} [symbol] ⱼ₌₁^{d}. The formulas for \hat{p} and \hat{m}^{j} are as follows:

$$\begin{matrix}\hat{p} = \vert {S}^{- 1} ‖ {Q}^{- 1} \vert {\sum }_{k = 1 … {K}_{B}} \overline{{z}_{k}} , \\ {\hat{m}}^{j} = {\sum }_{{k = 1 … {K}_{B}}_{k : {γ}_{k}^{j} \neq *}} \overline{{\overline{z}}_{k}} {γ}_{k}^{j} / {\sum }_{{k = 1 … {K}_{B}}_{k : {γ}_{k}^{j} \neq *}} \overline{{z}_{k}}\end{matrix} \qquad ( 16 )$$

Since most tuple pairs in S×Q belong to U (are not “true matches”), the parameters [symbol] u^{j} [symbol] ⱼ₌₁^{d} can be well approximated by ignoring the Z̅ₖ's altogether (setting them all to 0):

$${u}^{j} \approx \vert \{ k \vert \begin{matrix}1 \leq k \leq \vert S ‖ Q \vert \\ {γ}_{k}^{j} = 1\end{matrix} \} \vert / \vert \{ k \vert \begin{matrix}1 \leq k \leq \vert S ‖ Q \vert \\ {γ}_{k}^{j} \neq *\end{matrix} \} \vert \qquad ( 17 )$$

We take advantage of this approximation, and use EM only to estimate p and [symbol] m^{j} [symbol] ⱼ₌₁^{d} Once the EM iterations converge, we obtain all the parameters necessary to perform statistical tuple linkage between the tuples in S and in Q.

### 4.3 Proximity Measure

Return to the setup of Section 2 and consider a table S containing sensitive data and the query tables Q₁,Q₂, . . . ,Qₙ to be ranked by their proximity to S. The ranking is performed by optimally matching the tuples in each Qᵢ to the tuples in S and comparing the weights of these matches. According to Theorem 1, the fraction m(γ)/u(γ) is the best measure to quantify whether or not a comparison vector γ indicates a true match. Let us make the following definition.

Definition 5. The weight of a tuple pair [symbol] s,q [symbol] from S×Q, whose comparison vector is γ, is given by

$$w ( s , q ) = log \frac{m ( γ )}{u ( λ )} = {\sum }_{j = 1}^{d} \{ \begin{matrix} log \frac{{m}^{j}}{{u}^{j}} , & {γ}^{j} = 1 \\ log \frac{1 - {m}^{j}}{1 - {u}^{j}} , & {γ}^{j} = 0 \\ 0 , & {λ}^{j} = *\end{matrix}$$

The plus-weight of [symbol] s,q [symbol] is 0 if this tuple pair is labeled with U by blocking, otherwise it is defined as

$${w}^{+} ( s , q ) = \{ \begin{matrix}w ( s , q ) , & w ( s , q ) \geq 0 \\ 0 , & w ( s , q ) < 0\end{matrix} \qquad ( 18 )$$

We begin by computing the parameters \hat{p} and [symbol] \hat{m}^{j},û^{j} [symbol] ⱼ₌₁^{d} via the framework described in Section 4.2, where we set Q=Q₁ U Q₂U . . . U Qₙ. We take this duplicate preserving union and run EM over Q to ensure that all parameters are the same for all Qᵢ's. Blocking assigns U-labels to all tuple pairs [symbol] s,q [symbol] that do not share at least one “discriminating” attribute value; see Section 7 for details.

Having estimated the m^{j}'s and the uⁱ's, we use equation (18) to compute the plus-weights of all pairs in S×Qᵢ left unlabeled by blocking. All pairs labeled with U by blocking receive weight 0. Then for each Qᵢ we seek a maximum-weight matching that assigns each record in Qᵢ to one and only one record in S. The weight of a matching is defined as the sum of plus-weights of all matched pairs. Plus-weights are used so that negative weights never impact the matching process.

We compute the maximum-weight matching with the help of the Kuhn-Munkres algorithm for optimal matching over a bipartite graph, also known as the Hungarian algorithm. The weight of the matching is the proximity measure between Qᵢ and S that we output, to be used in ranking queries and measuring disclosure.

FIGS. 4a and 4b graphically portray the application of the statistical tuple linkage method to the problem of query ranking. FIG. 4a shows computed weights for all edges in S×Qᵢ, and FIG. 4b illustrates the result of using Kuhn-Munkres to maximize the sum of plus-weights assigned to edges while ensuring that each tuple in Qᵢ and S has at most one edge.

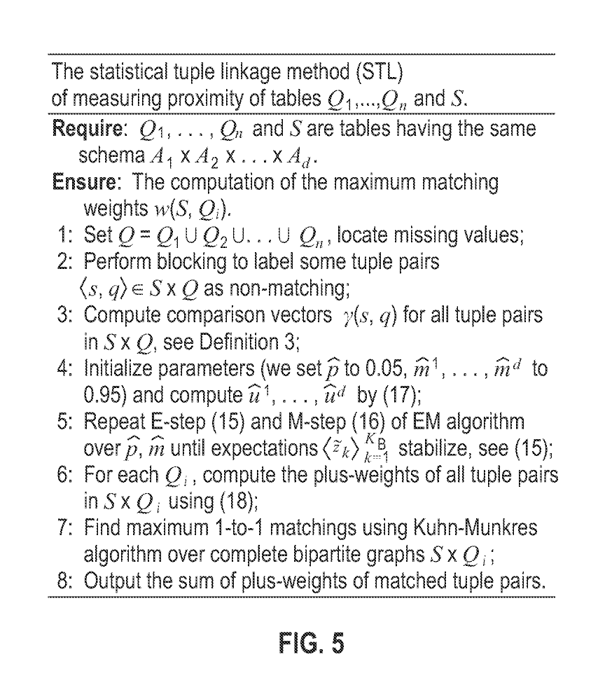

FIG. 5 shows a summary of the method of measuring proximity through statistical tuple linkage (STL) in accordance with the present invention.

### 5. Derivation Probability Gain

This method measures proximity between two tables Q and S based on the minimum-length (maximum-probability) derivation of S from Q. Intuitively, one can think of an archiver that tries to compress S given the tuples in Q. The compressed “file” includes both the new values in S recorded “as-is” and the link structure to copy the repeated values. The size of the archive, expressed through its probability, or more exactly the size difference made by the presence of Q, gives the proximity measure. We consider a specific compression procedure that uses the minimum spanning tree algorithm.

Definition 6. Given tables Q= [symbol] q₁, q₂, . . . , q|_{Q} [symbol] and S= [symbol] s₁,s₂, . . . , s|ₛ [symbol] a derivation forest from Q to S is a collection of disjoint rooted labeled trees {T₁,T₂ . . . , Tₖ} whose roots are in Q and non-root nodes are in S. The trees' bodies have to cover all tuples in S. A derivation forest defines for each sᵢ εS a single parent record π(sᵢ) ε Q ∪ S.

Statement 1. The number of possible derivation forests from Q to S equals |Q|(|S|+|Q|)^{|S|-}1.

We consider a generative model for S given Q with two parameter groups, for each attribute j=1 . . . d:
Matching probability μ^{j} ε[0, 1],
Default distribution p^{j}(v)over all v εAⱼ.
   In this model, we generate the tuples of S from the tuples of Q as follows:

1. Pick a derivation forest D uniformly at random. Forest D defines a parent π(sᵢ) for each record sᵢ ε S. According to Statement 1, the probability of D is:

P[D]=const=(|Q|(|S|+|Q|)^{|s|-1})⁻¹.

2. Generate the tuples of S in an order so that each sᵢ is always preceded by π(sᵢ). To generate tuple sᵢ= [symbol] sᵢ¹, sᵢ², . . . ,sᵢ^{a} [symbol] , for each j=1 . . . d do: Toss a Bernoulli coin zᵢ^{j} with probability μ^{j} to fall 1 and 1−μ^{j} to fall 0. If zᵢ^{j}=1, just copy the parent's j^{th} attribute value π^{j}(sᵢ) into sᵢ^{j}; if zᵢ^{j}=0, generate sᵢ^{j} independently according to the default distribution p^{j}(sᵢ^{j}).

Denote by Z the outcomes of all Bernoulli coins zᵢ. The joint probability of everything being generated, both hidden variables (D, Z) and observed tuples (S), given Q equals

$$\begin{matrix}P [ D , Z , S \vert Q ] = P [ D ] \cdot {\prod }_{i = 1}^{\vert S \vert} {\prod }_{j = 1}^{d} {{p}^{j} ( {s}_{j}^{i} )}^{1 - {z}_{i}^{j}} \times \\ {( {μ}^{j} )}^{{z}_{j}^{i}} {( 1 - {μ}^{j} ) }^{1 - {z}_{i}^{j}}\end{matrix} \qquad ( 19 )$$

with the constraint that sᵢ^{j}=π^{j(s}^{ᵢ}⁾ wherever zᵢ^{j}=1 (otherwise P[D,Z,S|Q]=0.

To measure proximity between tables Q and S, we use P[D,Z,S/Q] with hidden variables D and Z chosen to maximize this probability. This can be viewed as an instance of the minimum description length principle, where we choose best D and Z to describe S given Q. The “length” of description <D,Z,S> is computed as −log₂ P[D,Z,S/Q].

Definition 7. Let us define the weight w(sᵢ,t) of an edge between tuples sᵢε S and tε Q∪ S to be:

$$w ( {s}_{i} , t ) := {\sum }_{{j = 1 … d}_{{s}_{i}^{j} = {t}^{j}}} max \{ - log ( \frac{1 - {μ}^{j}}{{μ}^{j}} {p}^{j} ( {s}_{i} ) ) , 0 \}$$

Note the symmetricity: w(sᵢ,t)=w(t,sᵢ); this is important for our weighted spanning tree representation. Note also that edges [symbol] sᵢ,t [symbol] , whose matching attribute values sᵢ^{j}=tⁱ have low probability to occur randomly, are given more weight.

Statement 2. Probability of equation (19) reaches maximum when derivation forest D is chosen to maximize the sum

$$w ( D ) := {\sum }_{i = 1}^{\vert S \vert} w ( {s}_{i} , π ( {s}_{i} ) ) \qquad ( 20 )$$

Proof. Formula (19) can be rewritten as follows:

$$\begin{matrix}P [ D , Z , S \vert Q ] = P [ D ] \frac{{\prod }_{i = 1}^{\vert S \vert} {\prod }_{j = 1}^{d} {p}^{j} ( {s}_{i}^{j} )}{{\prod }_{i = 1}^{\vert S \vert} W ( {z}_{i} , {s}_{i} , π ( {s}_{i} ) )} & ( 21 ) \\ where W ( {z}_{i} , {s}_{i} , π ( {s}_{i} ) ) = {\prod }_{j = 1}^{d} \frac{{{p}^{j} ( {s}_{i}^{j} )}^{{z}_{i}^{j}}}{{( {u}^{j} )}^{{z}_{i}^{j}} {( 1 - {μ}^{j} )}^{1 - {z}_{i}^{j}}} & \end{matrix}$$

Since P[D]=const, this term does not affect the value of equation (19). Once D is fixed, we can pick optimal Z=Z*(D) by independently minimizing each W(zᵢ,sᵢ,π(sᵢ)), which becomes (recall that sᵢ^{j}≠π^{j}(sᵢ) [symbol] zᵢ^{j}=0):

$${W}_{opt} ( {z}_{i}^{*} , {s}_{i} , π ( {s}_{i} ) ) = {W}^{′} ( {s}_{i} , π ( {s}_{i} ) ) \cdot {\prod }_{j = 1}^{d} \frac{1}{1 - {μ}^{j}}$$

$$where {W}^{′} ( {s}_{i} , π ( {s}_{i} ) ) = {\prod }_{j : {s}_{i}^{j} = {π}^{j} ( {s}_{i} )}^{d} min \{ \frac{1 - {μ}^{j}}{{μ}^{j}} {p}^{j} ( {s}_{i}^{j} ) , 1 \}$$

By Definition 7, the weight w(sᵢ,π(sᵢ)) of an edge between tuples sᵢ and π(sᵢ) is equal to the negative logarithm of W′(sᵢ,π(sᵢ)) . Therefore, we can rewrite equation (21) for optimal Z=Z* as below:

$$\begin{matrix}log P [ D , {Z}^{*} , S \vert Q ] = log P [ D ] + {\sum }_{i = 1}^{\vert S \vert} w ( {s}_{i} , π ( {s}_{i} ) ) + \\ {\sum }_{i = 1}^{\vert S \vert} {\sum }_{j = 1}^{d} log {p}^{i} ( {s}_{i}^{j} ) + \vert S \vert {\sum }_{j = 1}^{d} log ( 1 - {μ}^{j} ) .\end{matrix} \qquad ( 22 )$$

It can be seen now that the optimal derivation forest D* is such that the sum of edge weights w(sᵢ,z(sᵢ)) over the trees in D* is maximized.

The search for the optimal maximum-weight D* is easily converted into a minimum (or maximum) spanning tree problem. Given tables Q and S, let G=(V,E) be an undirected graph with vertices V=Q∪S∪{ξ} where ξ is a new special vertex, and with edges formed by all (Q∪S)×S and {∪}×Q. Set edge weights according to Definition 7 for non-ξ edges, and set w(ξ,qᵢ)=wₘₐₓ for all qᵢ ε Q where wₘₐₓ is chosen larger than any non-ξ weight.

The symmetricity of weight function w(sᵢ,t) allows us to set one weight per edge, independently of its direction towards ξ.

Statement 3. There is a one-to-one correspondence be-tween maximum spanning trees for G and optimal derivation forests from Q to S.

Proof. Given a forest D*, a spanning tree is produced by adding vertex ξ and connecting all qᵢε Q to ξ. Given a spanning tree T over G that includes all edges connecting ξ and Q, a derivation forest is formed by discarding ξ and its adjacent edges. This forest has exactly one Q-vertex per each tree:

No Q-vertex would imply that some S-vertices are not connected to ξ in T;

Two Q-vertices would create a cycle in T as they are connected through S and through ξ.

Any maximum spanning tree T over G includes all ξ-edges since these are the heaviest edges: a tree without edge (ξ,qᵢ) gains weight by adding (ξ,qᵢ) and discarding the lightest edge in the resulting cycle. If the derivation forest over Q∪S that corresponds to T is not optimal, the tree gains weight by replacing this forest with a heavier one; hence, a maximum spanning tree corresponds to an optimal derivation forest. Conversely, if the spanning tree that corresponds to forest D* is not maximum-weight, the forest is not optimal because a heavier forest is given by any maximum spanning tree.

COROLLARY 1. Maximum probability P [D*,Z*,S|Q] can be computed by taking the weight w(T) of a maximum spanning tree over graph G formed as above, subtracting the −edge weights to get w(D*)=w(T−|Q|Wₘₐₓ, and using formula (22):

$$\begin{matrix}log P [ {D}^{*} , {Z}^{*} , S \vert Q ] = \\ = - log \vert Q \vert - ( \vert S \vert - 1 ) log ( \vert S \vert + \vert Q \vert ) + w ( {D}^{*} ) + \\ {\sum }_{i = 1}^{\vert S \vert} {\sum }_{j = 1}^{d} log {p}^{j} ( {s}_{i}^{j} ) + \vert S \vert {\sum }_{j = 1}^{d} log ( 1 - {μ}^{j} ) .\end{matrix} \qquad ( 23 )$$

PROOF. Follows from Statements 1, 2, and 3.

We compute the proximity measure between Q and S by comparing P[D*,Z*,S/Q] to the maximum derivation probability of S without Q, written as P[D**,Z**,S]. It is computed analogously to P[D*,Z*,S/Q] but with a “dummy” one-tuple Q, and represents the amount of information contained in S. The proximity between Q and S is defined as the log-probability gain for the optimal derivation of S caused by the presence of Q:

$$prox ( Q , S ) := log \frac{P [ {D}^{*} , {Z}^{*} , S \vert Q ]}{P [ {D}^{**} , {Z}^{**} , S ]} \qquad ( 24 )$$

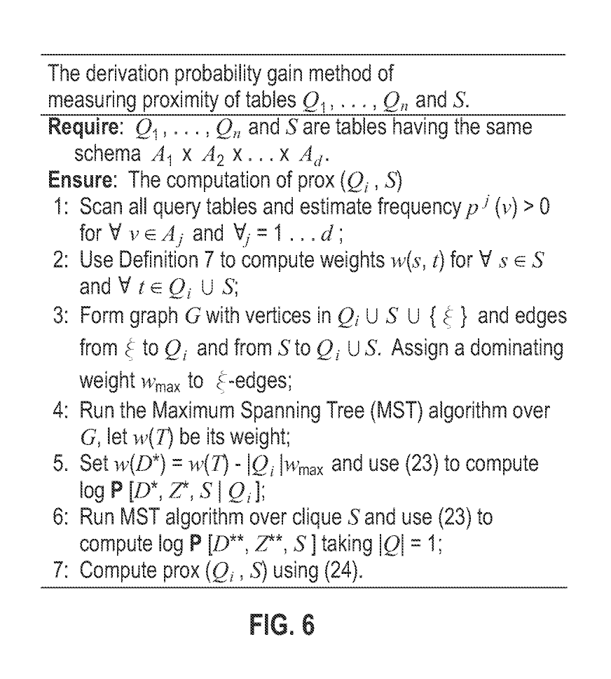

FIG. 6 summarizes the computation steps for the Derivation Probability Gain (DPG) method in accordance with one embodiment of the invention. In our experiments, we take ∀ⱼ:μ^{j}=½ and compute the default probabilities p^{j}(v) of attribute values as frequency counts across all query tables.

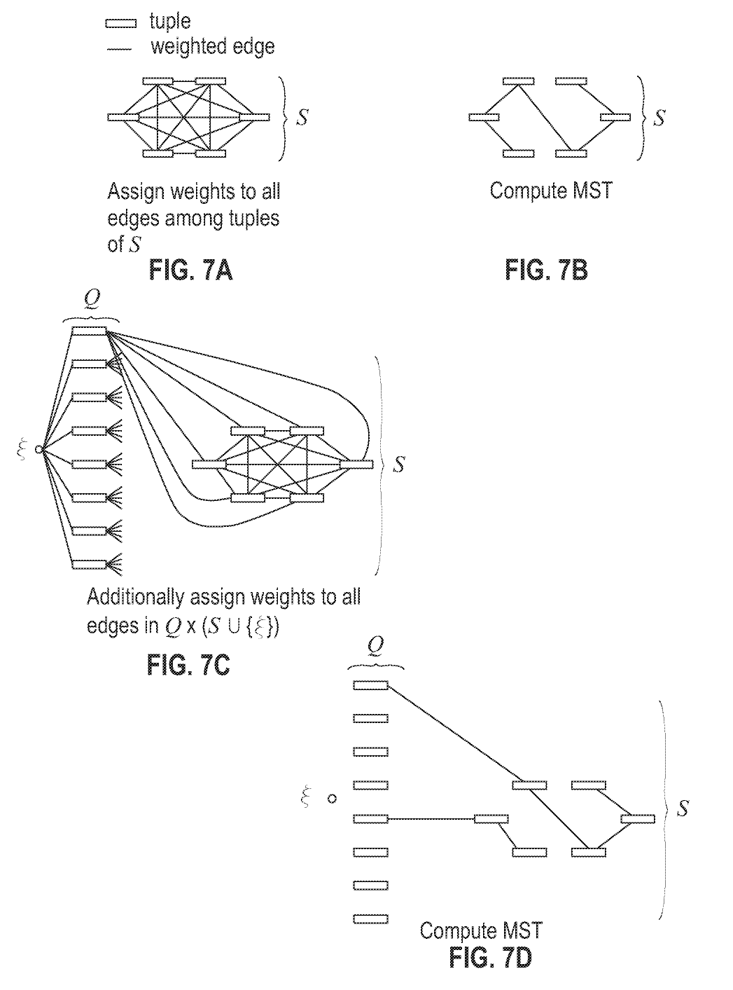

FIGS. 7a through 7d graphically illustrate the DPG method. In FIG. 7a, weights are assigned to all edges among tuples of S, and in FIG. 7b, a maximum spanning tree (MST) is computed based upon these weights. FIG. 7c adds the tuples of Q to the graph, computing and assigning weights betweens edges of Q×S. In FIG. 7d, a new maximum spanning tree is computed now using edges inside S and in Q×(S ∪{ξ}). The weights of the remaining edges are used to calculate the benefit of Q to S.

### 6. Comparison of the Methods

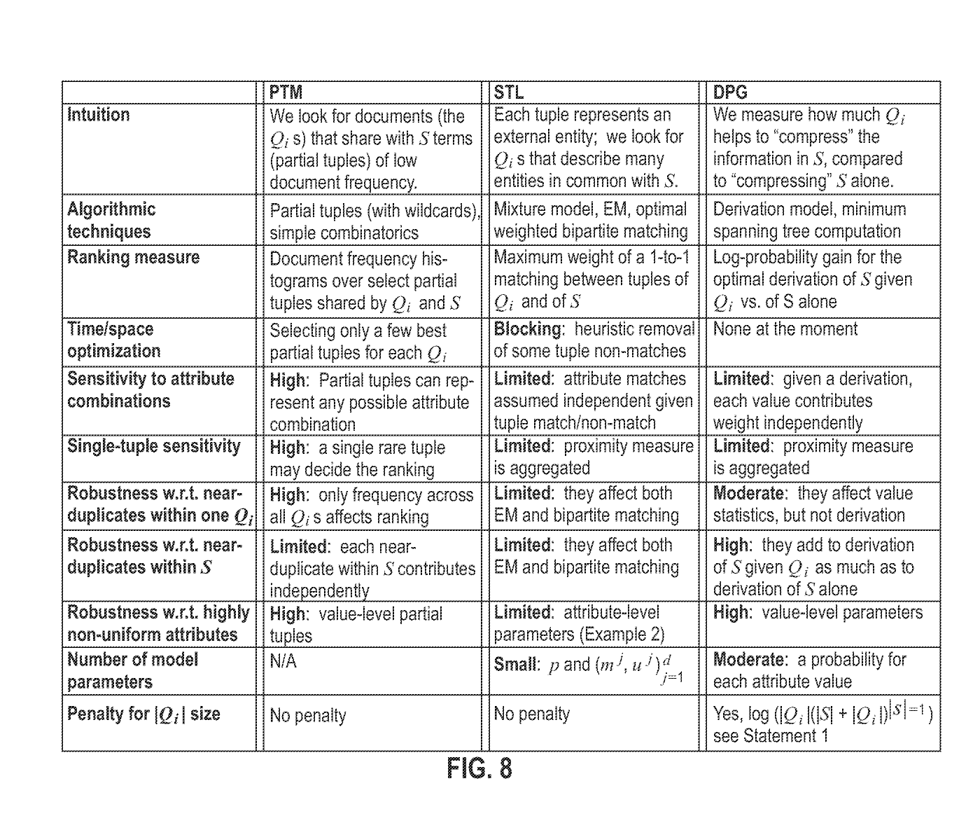

Let us take a step back and look at the big picture: what are the similarities and differences between these three ranking methods? All three methods look for matching attributes between the tuples of sensitive table S and of each query table Qᵢ, yet each method uses different intuition and techniques, resulting in different behavior. FIG. 8 shows a table of some of the characteristics of the three methods in accordance with various embodiments of the invention.

For Partial Tuple Matching (PTM) the most important ranking factor is the “document frequency” of partial tuples shared between S and Qᵢ: the number of other query tables that also contain these shared tuples. The two other methods compute their statistics over all tuples in the union Q₁∪Q₂∪ . . . ∪Qₙ, which is vulnerable to the bias caused by repetitive data and by the variation in the query table size |Qᵢ|. On the other hand, document frequency may be a poor statistic if the number of queries is small. Thus, PTM ranking is combinatorial rather than statistical. The PTM method counts frequency of attribute combinations (partial tuples), while the other two methods account for each matching attribute individually in tuple comparisons.

The Statistical Tuple Linkage (STL) method stems from the assumption that the tuples in S and Qᵢ represent external entities, and works to identify same-entity tuples. Its probability parameters [symbol] m^{j},u^{j} [symbol] ⱼ₌₁ⁱ treat equally all values of the same attribute and assume conditional attribute independence. If the values of a certain attribute have a strongly non-uniform distribution, some being rare and highly discriminative and others overly frequent, the method will show suboptimal performance (see Example 2). Missing/default values receive special attention in STL since they differ significantly from other values, and blocking improves efficiency.

### EXAMPLE 2

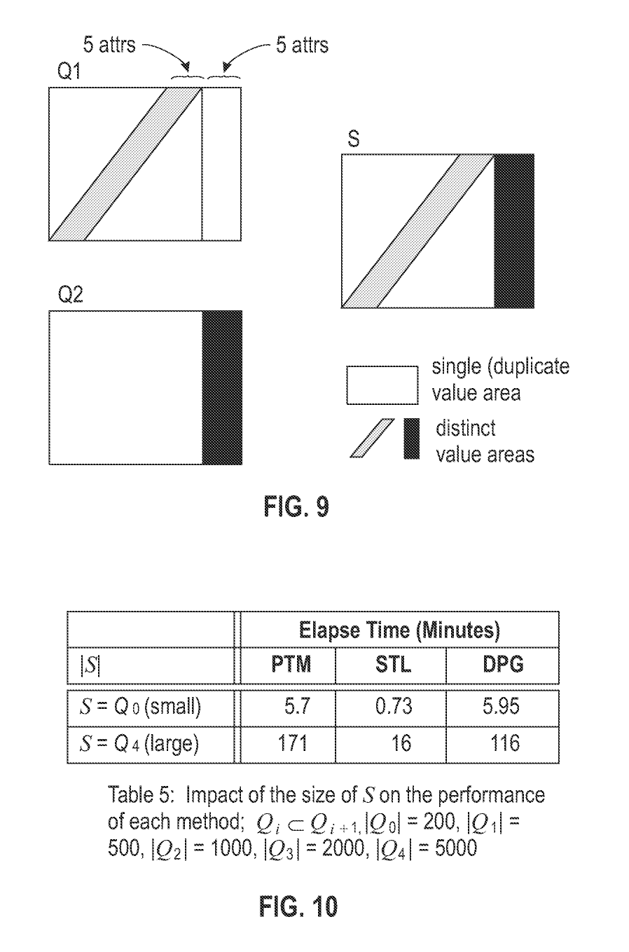

In FIG. 9, the white areas represent attributes all having the same value, say zero. The grey area represents attributes having unique values. Same-colored areas in Q₁,Q₂ match with S; the proportion of diagonal and vertical grey areas are equal. STL ranks Q₂ above Q₁ while PTM and DPG rank Q₁ and Q₂ equally. The difference for STL is due to the non-uniform distribution of values in “diagonal” attributes (some values are common and others unique).

The intuition behind Derivation Probability Gain (DPG) is that shared information between S and Qᵢ helps to compress S better in the presence of Qᵢ than alone. Because tuples in S can be “compressed” by deriving them from other S-tuples (even without Qᵢ), DPG may be better than the other two methods if S contains many duplicates or near-duplicates. However, DPG makes certain attribute independence assumptions and collects value statistics by counting tuples in query tables, which is prone to bias.

### 7. Experimental Results

We implemented the three proposed methods as Java applications and performed experiments on a Windows XP Professional Version 2002 SP 2 workstation with 2.4 GHz Intel Xeon dual processors, 2 GB of memory, and a 136 GB IBM ServeRAID SCSI disk drive.

We used the IPUMS data set as described in S. Ruggles, M. Sobek, T. Alexander, C. A. Fitch, R. Goeken, P. K. Hall, M. King, and C. Ronnander. Integrated public use micro data series: Version 3.0, 2004. Machine-readable database, which is incorporated herein by reference. The complete dataset consists of a single table with 30 attributes, and 2.8 million records with household census information. We used random samples from this dataset for our experiments below. For each attribute in the IPUMS dataset, missing values are represented by specific values. For example, a value of 99 for IPUMS attribute “statefip” represents an unknown state of residence rather than a household's state of residence. For the STL method, missing attribute values are omitted from rank score calculations and from parameter estimation as described in Section 4.2. We used the following blocking strategy for the STL method. For a pair of tuples [symbol] s,q [symbol] ε S×Q to be considered as a possible match, s and q must match on at least one of their discriminating attribute values. Otherwise, the pair is discarded or blocked.

An attribute value vis considered discriminating depending upon the number of tuples in S and in Q with that attribute value; computed as the product ρ(v) of the number of tuples in S having the value v in attribute Aⱼ and the number of tuples in Q with the same value. If ρ(v)<|Q|, we consider v to be discriminating.

Ideally, we would like to rank queries higher if they have a greater chance of being a source of information contained in S. We formulate some desirable properties to compare our ranking methods in experiments:

1. Given a single query Q₁ whose tuples have been inserted into table S, and other queries Q₂, . . . ,Qₙ that have not contributed any tuples to S, no query Q₂, . . . , Qₙ is ranked above Q₁.

2. Given queries Q₁,Q₂ whose tuples have been inserted into table S and other queries Q₃, . . . ,Qₙ that have not contributed any tuples to S, no query Q₃, . . . , Qₙ is ranked above Q₁ or Q₂.

3. Given queries Q₁, Q₂ whose tuples have been inserted into table S, and the tuples inserted into S by Q₁ are a superset of those inserted by Q₂, Q₁ is ranked above Q₂.

4. Given queries Q₁,Q₂ having inserted the same subset of tuples into table S, and the number of tuples in Q₂ is larger than Q₁, Q₁ is ranked above Q₂.

5. Given that S may have been subsequently updated and thus some attribute values are retained while others are modified, the above properties hold.

Property 1 says that if S has been copied from a single query Q₁, then Q₁ should be ranked first. Properties 2 to 4 address the usage of multiple queries to populate S. Property 5 allows for the possibility that the data might have been updated over time and that tuples in Qᵢ and S now match only on some of their attribute values.

### 7.1 Match Set Size

We used queries Q₀, . . . , Q₅, each with 1000 randomly selected tuples such that:

|Qᵢ|=1000, |Qᵢ∩Qⱼ|0, i≠j, |Q₀∩S|=0, |Q₁∩S|=200, |Q₂∩S|=400, |Q₃∩S|=600, |Q₄∩S|=800, |Q₅∩S|=1000, |S|=3000.

For each

Qᵢ, Qⱼ, |Qⱼ∩S|>|Qᵢ∩S|, j>i.

Random selection was done by assigning each tuple a distinct random number 0, . . . ,n−1, where n is the dataset size and selecting tuples on ranges of these numbers. This experiment is intended to give an indication of the goodness of each method with respect to Properties 1 to 3. All three methods exhibited similar goodness with respect to these properties since each Qᵢ+1 ranked above Qᵢ.

### 7.2 Overlapping Matching Sets

In these experiments,

Qᵢ⊂Qᵢ₊₁, |Q₀|=200, |Q₁|=500, |Q₂|=1000, |Q₃|=2000, |Q₄|=5000.

In a first experiment, the sensitive table S is identical to query Q₀ with 200 tuples. In a second experiment, the sensitive table S is identical to query Q₄ with 5000 tuples. In both experiments, each larger query includes all tuples of the smaller sizes. These experiments are intended to give an indication of the goodness of each method with respect to Properties 1 through 4. In the first experiment, PTM and STL rank all queries equally since they have no penalty for query size. However, DPG has a penalty for query size and ranks Qᵢ+1 below Qᵢ due to its greater size and extraneous tuples with respect to S. In the second experiment, all three methods have similar goodness as each Qᵢ+1 ranked above Qᵢ.

### 7.3 Perturbation

This experiment was intended to give an indication of the goodness of each method with respect to Property 5. The perturbation reflects the fact that the tuples in S might, for example, have been updated after the time the data was acquired by the 3rd party to the time the data was recovered by the party claiming to be its rightful owner and source. In this experiment,

|Q₀|=1000, |S|=1000, |Q₀∩S|=1000

before tuples in S are perturbed, and,

|Qᵢ|=1000, |Qᵢ∩S|=0, |Qᵢ∩Qⱼ|=0, iε1, . . . 5, i≠j.

A percentage of values are perturbed in S (we perturbed 20%, 40%, 60%, 80% of values in S in separate experiments); perturbed values could appear in any attribute. All methods correctly ranked Q₀ above Q₁, . . . , Q₅.

### 7.4 Performance

FIG. 10 is a table showing the elapse time in minutes that each method required to compute the results presented in Section 7.1. These results show the impact of the sensitive table size on the performance of each method. FIG. 10 contrasts a small size of S (S is Q₉,|Q₀|=200) verses a large size (S is Q₄,|Q₄|=5000). The results show that all methods are sensitive to both the size of S and Q, but that the STL method has overall the best performance. With the STL method, simple comparisons among attribute values in tuples of Q and S are used to generate the comparison vector γ which is then used in the iterative step of the EM algorithm. The PTM method requires complex comparisons to determine if a tuple either matches or is partially matched by another tuple. Since the number of these comparisons is determined by |S|, the PTM method is significantly impacted by this cost when |S| is large. We used indices to optimize these comparisons. However, these indices are in-memory Java objects that consume additional memory resources, thus also having an impact on performance. In comparison with the STL method, the DPG method computes comparisons among tuples in S in addition to comparisons between tuples of Q and S.

We note that the performance of the STL method can be further improved by increasing the level of blocking, as long as it does not significantly affect the accuracy of ranking. It may also be possible to apply similar types of optimizations to the DPG method to improve its performance.

### 8. Conclusion

In accordance with the present invention, we have disclosed systems and methods for ranking a collection of queries Q₁, . . . , Qₙ over a database D with respect to their proximity to a table S which is suspected to contain information misappropriated from the results of queries over D. We have proposed, developed and contrasted three conceptually different query ranking methods, and experimentally evaluated each method.

Although the embodiments disclosed herein may have been discussed used in the exemplary applications, such as applications where the sensitive data in table S is patient medical data, those of ordinary skill in the art will appreciate that the teachings contained herein can be apply to may other kinds of data. Similarly, while the experimental results were obtained with an embodiment implemented on Java, those of ordinary skill in the art will appreciate that the teachings contained herein can be implemented using many other kinds of software and operating systems. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

While the preferred embodiments of the present invention have been described in detail, it will be understood that modifications and adaptations to the embodiments shown may occur to one of ordinary skill in the art without departing from the scope of the present invention as set forth in the following claims. Thus, the scope of this invention is to be construed according to the appended claims and not limited by the specific details disclosed in the exemplary embodiments.

We claim:

1. A method for identifying the source of an unauthorized database disclosure comprising:
storing a plurality of query results comprising the results of past database queries;
determining the relevance of said query results to a sensitive table containing disclosed data by measuring the proximity of said query results to said sensitive table based on partial tuple matches between said query results and said sensitive table and by finding the best one-to-one match between the closest tuples in said query results and said sensitive table;
said finding including generating a score for each said one-to-one match and evaluating the overall proximity between said query results and said sensitive table by aggregating said scores of individual matches using statistical record matching, mixture model parameter estimation and expectation maximization to find said best one-to-one match;
ranking said past database queries based on said determined relevance by evaluating the proximity of said sensitive table to said query results by computing the gain in probability for tuples in said sensitive table through their maximum-likelihood derivation from said query results and by assigning weights to all edges among tuples of said sensitive table and using a minimum spanning tree algorithm based on said weights to compress said sensitive table given said tuples in said query results; and
generating a list of the most relevant past database queries ranked according to said relevance, whereby the highest ranked queries on said list are most similar to said disclosed data.

2-20. (canceled)
